(19) United States
(12) Patent Application Publication
(10) Pub. No.: US 2014/0329131 A1
(43) Pub. Date: Nov. 6, 2014

(54) HEAT RESISTING SEPARATOR HAVING ULTRAFINE FIBROUS LAYER AND SECONDARY BATTERY HAVING THE SAME

(71) Applicant: Korea Institute of Science and Technology, Seoul (KR)

(72) Inventors: Seong-Mu Jo, Seoul (KR); Dong-Young Kim, Seoul (KR); Byung-Doo Chin, Gyeonggi-Do (KR)

(21) Appl. No.: 14/310,038

(22) Filed: Jun. 20, 2014

Related U.S. Application Data
(62) Division of application No. 12/376,516, filed on Aug. 19, 2010.

(30) Foreign Application Priority Data
Aug. 7, 2006 (KR) 10-2006-0074390

(51) Int. Cl. H01M 2/16

(52) U.S. Cl. CPC H01M 2/162; H01M 2/1666
USPC 429/145

(57) ABSTRACT

A polyolefin separator having an heat-resistant ultrafine fibrous layer and a secondary battery using the same, in which the separator has a shutdown function, low thermal contraction characteristics, thermal endurance, excellent ionic conductivity, excellent cycling characteristics at the time of battery construction, and excellent adhesion with an electrode. The present invention adopts a very simple and easy process to form an ultrafine fibrous layer through an electrospinning process, and at the same time, to remove solvent and to form pores. Accordingly, the separator of the present invention is useful particularly for electrochemical devices used in a hybrid electric automobile, an electric automobile, and a fuel cell automobile, requiring high thermal endurance and thermal stability.

### TECHNICAL FIELD

The present invention relates to a heat-resistant separator having a heat resisting ultrafine fibrous layer, and more particularly to a separator and an electrochemical device using the same, in which the heat resistant ultrafine fibrous layer is coupled to one or both surfaces of a porous separator, thereby having a shutdown function, excellent thermal endurance, less thermal contraction as well as having an excellent ionic permeability and charge-discharge characteristics.

### BACKGROUND ART

As the needs of consumers have changed due to digitization and the higher efficiency of electronics products, a new trend is driving development of thin and light batteries with higher capacity by high-energy density, including secondary batteries such as a lithium ion secondary battery, a lithium ion polymer battery, and a super capacitor (electric double layer capacitor and pseudo-capacitor). And, in order to deal with problems in the future energy and the environment, developments of hybrid electric vehicles, electric vehicles and fuel cell vehicles have actively progressed. Accordingly, large-sized batteries for an automobile electric power source are required.

A secondary battery having a high-energy density has a relatively high operating temperature range, and the temperature thereof would increase when it is continuously used in a high-rate charge-discharge state. Accordingly, it requires thermal endurance and thermal stability higher than those which are required in a general separator. A separator is disposed between the anode and the cathode of the battery for insulation, holds an electrolyte solution to provide a conduit for ionic conduction, and has a shutdown function so that when the temperature of the battery rises excessively, the separator is partially melted to close its pores thus to block an electric current. When the temperature goes higher, the separator is melted, and then a big hole is created, causing a short-circuit between the anode and the cathode. This temperature is called the “short circuit temperature.” Generally, a separator should have a low shutdown temperature and a higher short circuit temperature.

When a battery abnormally generates heat, a polyethylene separator is contracted at a temperature more than 150° C. and exposes the electrode portion thereof, indicating the possibility to cause a short circuit.

Accordingly, in expectation of contraction of about 20%, a separator additionally having 20% more area is used. Generally, this causes the weight of the battery to increase and the volumetric efficiency to decline, without any advantage at the time of charging-discharging. In particular, the thinner the separator, the lower the short circuit temperature. Thus, when a thinner separator is used, a separator having excellent heat-resistance is required to implement high-energy density. Accordingly, it is very important for the secondary battery of a high-energy density and a large size to have both a shutdown function and thermal endurance. That is, a separator is needed which has excellent thermal endurance thus to have less thermal contraction and excellent cycling performance.

Since lithium, which is very light in molecular weight and high in density, implements energy integration, a lithium secondary battery is proposed as a solution for a high-capacity battery (for example, a lithium ion battery, a lithium polymer battery, etc.). The lithium secondary battery at an early stage was prepared by using lithium metal or lithium alloy as the cathode. However, the secondary battery which uses the lithium metal or lithium alloy as the cathode forms dendrites on the cathode because of repeated charge-discharge cycles, resulting in low cycling characteristics.

A lithium ion battery was introduced to solve the problem due to the dendrite formation. The lithium ion battery is formed of a cathode active material, an anode active material, an organic electrolyte, and a polyolefin-based separator. The separator serves to permeate ions and to prevent an internal short circuit due to contact between the cathode and the anode of the lithium ion battery. Currently, separators using polyethylene or polypropylene materials are generally used.

Since a polyethylene or polypropylene separator does not have affinity for an electrolyte solution, liquid electrolyte solution is leaked. Accordingly, a sealed metallic can is used as the case to secure safety, causing the battery to become heavy in weight. And, the lithium ion battery has a danger of leakage and explosion due to the electrolyte solution filled in the metallic can, forms dendrites when overcharged, and requires a protective circuit against gas generated by decomposing of the electrolyte solution. Besides, since it is used in a circular cell case rolled with the cathode, the anode and the separator, it is difficult to prepare a cell in another form other than the circular cell. Along with complicated manufacturing processes and very high manufacturing cost, it is difficult to prepare a cell having a large size and high-capacity.

A more advanced lithium-ion battery design is a lithium polymer battery. Since the lithium polymer battery uses a polyelectrolyte instead of using the liquid electrolyte and the separator inserted between the cathode and the anode of the battery, the leakage problem is solved by not using the liquid electrolyte and also the danger of explosion becomes lower. It becomes lighter in weight by using an aluminum pouch, instead of a metallic can. Also, various kinds of battery manufacture (flat batteries or thin batteries) can be possible using polymer-specific plasticity. The polymer electrolyte used in the lithium-ion polymer battery, such as a gel polymer electrolyte or a plasticized polymer electrolyte, holds the liquid electrolyte solution in a polymer matrix having a porous structure. Even though the polymer electrolyte has a sufficient ionic conductivity of more than 10⁻³ Scm⁻¹ at room temperature, it is dissolved at a high temperature due to the thermoplasticity of the electrolyte, indicating the possibility of a short circuit of the battery. That is, it does not have a shutdown function serving as a main function of the separator, and has weak mechanical properties.

In order to solve the above-mentioned problems, there is provided a method for coating a polyolefin separator which is used in a conventional lithium-ion battery with the polymer electrolyte solution. The separator is disposed between the anode and the cathode of the battery, and then together rolled into a certain shape to be inserted into an aluminum pouch. Herein, a solution mixed with a monomer, catalyst, solvent, and lithium salt is added thereto, and then sealed. After heat is applied thereto, a battery is prepared by cross-linking of polymer chains. Since the battery is easy to prepare and uses a separator of an existing lithium-ion battery, it has good mechanical properties and excellent electrochemical properties, such as a high ionic conductivity, the low interfacial resistance, etc.

However, in a state that the battery is completely assembled, the above method induces a crosslinking reaction with monomers and catalysts inside the battery. This may cause residual monomers because all reactive group of monomers do not participate into the reaction. Accordingly, the residual reactive group even deteriorates the performance of the battery by participating in the electrochemical reaction.

In Japanese Patent Laid Open Publication No. 2006-92848 and Japanese Patent Laid Open Publication No. 2006-92847, there is provided a method for cross-linking a reactive polymer with an epoxy hardener, in which a polyolefin porous film which is supported in reactive polymers containing an epoxy resin hardener is laminated and pressed on the electrode, and thereafter the laminated body is immersed into the electrolyte solution to inject the electrolyte solution. However, after the anode, the cathode, and the separator are rolled together, in a part where the liquid electrolyte is impregnated, the liquid electrolyte impregnation rate is very slow, resulting in the manufacturing process taking a long time. The reason for the impregnation to take so long is that the porosity of the separator being used is only about 40%, so the liquid electrolyte could not be impregnated within a short period of time.

In Korean Patent No. 10-0470314, there is provided a composite film which integrates an ultrafine fibrous layer of a homopolymer or copolymer of polyvinylidene fluoride through an electrospinning process with a polyolefin porous film in order to prepare a separator enhancing the speed of electrolyte injection, performing uniform absorption of the electrolyte solution, and having excellent mechanical strength and bonding force with the electrode. However, it does not provide the thermal endurance required by batteries having a high-capacity and large size, for example, for automobiles.

In United States Patent Publication No. 2006/0019154 A1, there is provided a heat-resistant polyolefin separator in which a polyolefin separator is impregnated in a solution of polyamide, polyimide, and polyamidimide having a melting point of more than 180° C., and is then immersed into a coagulation solution, thereby extracting a solvent and adhering a porous heat-resistant resin thin layer thereto, which is claimed to have less thermal contraction, excellent thermal endurance, and excellent cycling performance. The heat-resistant thin layer provides porosity through the solvent extraction, and the polyolefin separator, of which the air permeability is less than 200 sec/min, is limited in use.

In Japanese Patent Laid Open Publication No. 2005-209570, in order to secure sufficient stability for a high-energy density, there is provided a polyolefin separator, in which both surfaces of the polyolefin separator were deposited with a heat-resistant resin solution such as aromatic polyamide, polyimide, polyethersulfone, polyetherketone, and polyetherimide having a melting point of more than 200° C., and then immersed-washed-dried in a coagulation solution, thereby adhering a heat-resistant resin. In order to reduce the deterioration of the ionic conductivity, the phase separator for providing porosity is contained in the heat-resistant resin solution and limited to the heat-resistant resin layer of 0.5-6.0 g/m².

However, immersion in the heat-resistant resin causes the pores of the polyolefin separator to be blocked and the movement of the lithium ions to be restricted, resulting in deterioration in the charge-discharge characteristics. Even though thermal endurance is secured, the need for a high-capacity battery for automobiles is not satisfied. Further, the manufacturing process for the porous heat-resistant resin layer, in which the heat-resistant resin is deposited and then is immersed-washed-dried in the coagulation solution, is very complicated and requires high manufacturing cost.

### DISCLOSURE OF THE INVENTION

### Technical Problem

To overcome these problems and in accordance with the purpose of the present invention, as embodied and broadly described herein, there is provided a separator and a secondary battery using the same, in which the separator has a shutdown function, low thermal contraction characteristics, thermal endurance, excellent ionic conductivity and adhesion with an electrode, excellent cycling characteristics at the time of battery construction, high energy density and high capacity, and is usable in a secondary battery including a lithium-ion secondary battery, a lithium ion polymer battery and a super capacitor (electric double layer capacitor and pseudo-capacitor).

Another object of the present invention is to provide a method for introducing a porous heat-resistant layer to a polyolefin separator in a very easy and economical way in order to provide a polyolefin separator with a porous heat-resistant layer, without requiring complicated processes which have been conventionally used (e.g. impregnation, coagulation, washing, and pore formation of heat-resistant resin).

### Technical Solution

To achieve these and other advantages and in accordance with an aspect of the present invention, there is provided a heat-resistant separator having an ultrafine fibrous layer, as a separator coated with a fibrous layer on either one or both surfaces of a porous film, in which the fibrous layer includes a fibrous form which is formed by electrospinning a heat-resistant polymeric material having a melting point of more than 180° C. or without a melting point.

Preferably, the fibrous layer may further include a fibrous form which is formed by electrospinning a swelling polymeric material in which swelling occurs in an electrolyte solution.

Further, the electrospinning may include electro-blowing, meltblowing or flash spinning.

Further, the porous film may include a polyolefin-based resin.

To achieve these and other advantages and in accordance with another aspect of the present invention, there is provided a secondary battery including two different electrodes; a heat-resistant separator having an ultrafine fibrous layer, which is inserted between the two electrodes and is coated with the fibrous layer on either one or both surfaces of a porous film, the fibrous layer including a fibrous form which is formed by electrospinning a heat-resistant polymer material having a melting point of more than 180° C. or without a melting point; and an electrolyte.

Preferably, the fibrous layer may further include a fibrous form which is formed by electrospinning a swelling polymeric material in which swelling occurs in an electrolyte solution.

### Effect of the Invention

The present invention provides a polyolefin separator having an heat-resistant ultrafine fibrous layer and a secondary battery using the same, in which the separator has a shutdown function, low thermal contraction characteristics, thermal endurance, excellent ionic conductivity, excellent cycling characteristics at the time of battery construction, and excellent adhesion with an electrode.

In order to introduce a porous heat-resistant resin layer, the present invention adopts a very simple and easy process to form an ultrafine fibrous layer through the electrospinning process, and at the same time, to remove solvent and to form pores, compared to the complicated processes in the related art (i.e. washing to remove a solvent, drying, pore removal through an impregnation method).

Accordingly, the polyolefin separator having an heat-resistant ultrafine fibrous layer and the secondary battery using the same in the present invention are particularly useful for electrochemical devices requiring high thermal endurance and thermal stability, such as a hybrid electric automobile, an electric automobile, and a fuel cell automobile, in which the secondary battery includes a lithium-ion battery, a lithium-ion polymer battery and a super capacitor (electric double layer capacitor and pseudo-capacitor).

### BRIEF DESCRIPTION OF THE DRAWINGS

FIG. 1 illustrates an electrospinning process for preparing a heat-resistant separator having an ultrafine fibrous layer in accordance with an embodiment of the present invention;

FIG. 2 is a SEM (scanning electron microscope) picture of a polyimide/polyvinylidene fluoride-co-hexafluoropropylene composite ultrafine fibrous layer surface prepared through an electrospinning process in accordance with one embodiment of the present invention; and

FIG. 3 is a graph showing a shutdown function of a polyethylene porous film coated with a heat-resistant polymer ultrafine fibrous layer in accordance with one embodiment of the present invention.

### MODES FOR CARRYING OUT THE PREFERRED EMBODIMENTS

Reference will now be made in detail to the preferred embodiments of the heat-resistant separator having an ultrafine fibrous layer according to the present invention.

According to the present invention, there is provided a polyolefin separator, in which an ultrafine fibrous layer of a heat-resistant polymer resin prepared by the electrospinning process is integrally adhered to a porous polyolefin film.

According to the present invention, electrospinning is a method for forming a heat-resistant ultrafine fibrous layer on either one or both surfaces of a polyolefin porous film. A typical principle of electrospinning is mentioned in many literatures, such as G. Taylor. Proc. Roy. Soc. London A, 313, 453 (1969); J. Doshi and D. H. Reneker, K. Electrostatics, 35 151 (1995). Following is a brief description of electrospinning.

Unlike electrostatic spraying in which liquid low in viscosity is sprayed in ultrafine droplets under an electric field of a high-voltage greater than a threshold voltage, electrospinning refers to a process whereby ultrafine fiber is formed when a polymer solution or melt body having sufficient viscosity is subjected to a high-voltage electrostatic force.

The heat-resistant ultrafine fibrous layer in the present invention is formed by using a modification of the conventional meltblown spinning or flash spinning process and the like, extending the concept of the electrospinning process, for example, by an electro-blowing method. Therefore, the electrospinning process in the present invention may include all those methods.

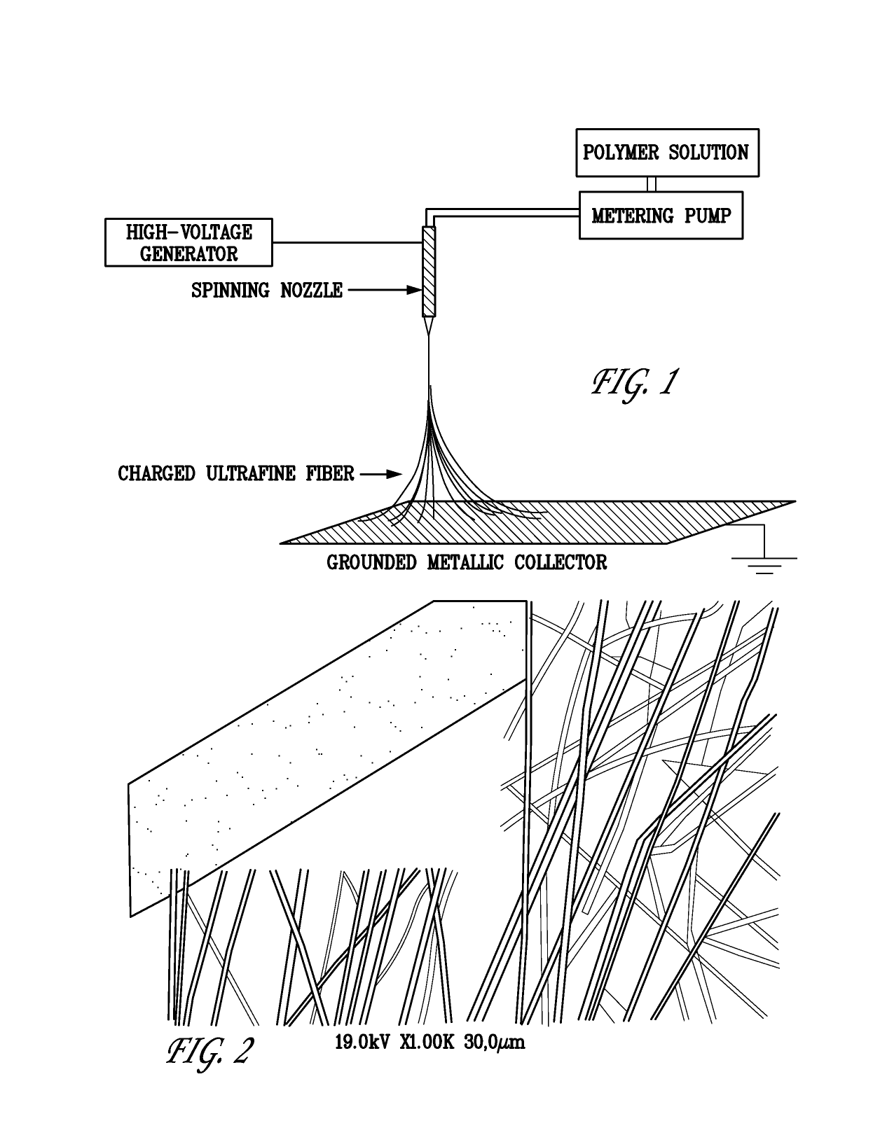

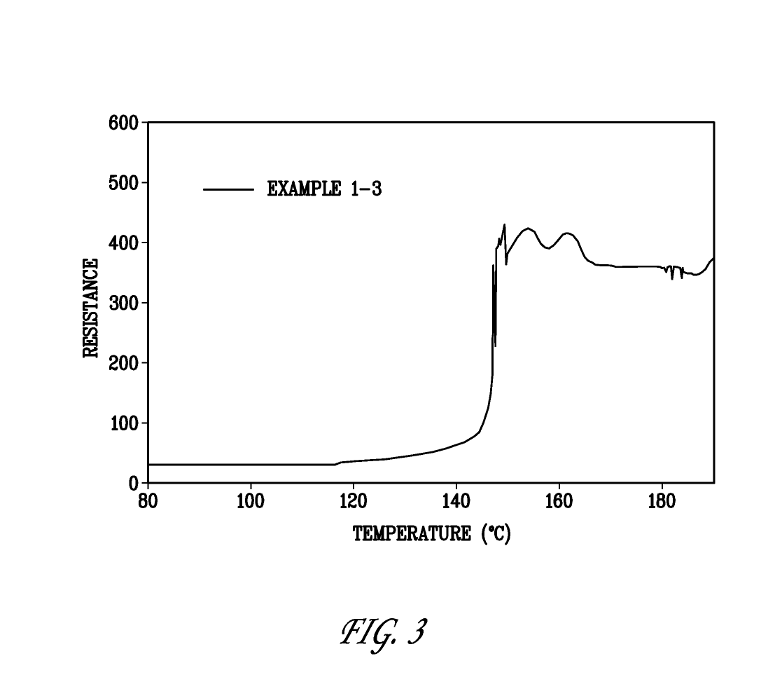

FIG. 1 is a schematic view showing an electrospinning apparatus. The apparatus includes a barrel that stores a heat-resistant polymer resin solution, a metering pump that discharges the heat-resistant polymer solution at a constant rate, and a spinning nozzle that is connected to a high-voltage generator. The heat-resistant polymer solution discharged through the metering pump is discharged as ultrafine fibers through the spinning nozzle charged by the high-voltage generator, and is collected on a polyolefin porous film located on a grounded collector that is shaped like a conveyor and moved at a constant speed. As shown in FIG. 2, the heat-resistant polymer solution discharge through the electrospinning process results in the preparation of ultrafine fibers of several nm to several thousands nm. Upon the formation of fibers, a porous web that is fused and laminated as a 3-dimensional network-structure may also be prepared. This ultrafine fiber web is an ultra-thin film, ultra light weight, has an extremely high volume to surface area ratio compared to conventional fibers, and is high in porosity.

In the cited references, a polyolefin separator is coated with a heat-resistant polymer resin solution dissolved in an organic solvent. The heat-resistant polymer layer and porous structure are formed by immersing-coagulating-washing-drying the separator coated into the coagulation solution of water or an aqueous solution of the organic solvent.

Accordingly, the porous structure of the polyolefin film is blocked by the heat-resistant polymer resin, thereby reducing the ionic conductivity, making it very difficult to control the porosity and the pore size distribution of the heat-resistant polymer layer and to perform very complicated processes such as the solvent extraction, washing-drying and the like.

However, in the formation of the heat-resistant ultrafine fibrous layer through electrospinning according to the present invention, as shown in FIG. 1, a solvent is evaporated during the ultrafine fibrous formation process and the porous structure is formed by gaps between the accumulated ultrafine fibers and fibers, thereby forming uniform pores. Further, no solvent extraction process or pore formation process as used in the cited references is additionally required.

A lithium secondary battery generates much gas inside the battery at the time of the first electric charging after the battery is sealed. This gas generation causes bubbles to be generated between the electrode and the polymer electrolyte layer, thereby rapidly deteriorating the battery performance due to poor contact. The coated heat-resistant porous layer in the cited references may cause the deterioration in the battery performance due to this generated gas. However, the heat-resistant ultrafine fibrous layer in accordance with the present invention does not cause problems due to gas generation.

The porous polyolefin-based film which is used in the present invention includes a separator and a non-woven fabric prepared by a polyolefin-based resin, such as polyethylene (PE), polypropylene (PP) and copolymers thereof. The porous polyolefin-based film has a melting point of 100-180° C., preferably 120-150° C. for a shutdown function. The pore size of the porous polyolefin-based film is 1-5000 nm. The porosity is in the range of 30-80%, preferably 40-60%.

The heat-resistant polymer resin which is used in the present invention is of a heat-resistant resin having a melting point of more than 180° C. so that the melt-down of the separator can be prevented when the temperature continually rises after the polyolefin separator performs the shutdown function. For example, the heat-resistant polymer resin constituting the heat-resistant polymer ultrafine fibrous layer includes an aromatic polyester, such as polyamide, polyimide, polyamidimide, poly(meta-phenylene isophthalamide), polysulfone, polyether ketone, polyether imide, polyethylene terephthalate, polytrimethylene terephthalate, polyethylene naphthalate, etc., a polyphosphazene group such as polytetrafluoroethylene, poly diphenoxy phosphazene, poly{bis[2-(2-methoxyetoxy)phosphazene]}, a polyurethane copolymer including polyurethane and polyetherurethane, and a resin having a melting point of more than 180° C. or without a melting point, such as cellulose acetate, cellulose acetate butylate, cellulose acetate propionate, etc. Herein, a resin without a melting point refers to a resin which burns without melting even at a temperature of more than 180° C.

Preferably, the heat-resistant polymer resin used in the present invention is dissolved in an organic solvent for an ultrafine fiberization such as electrospinning.

According to the present invention, the heat-resistant ultrafine fibrous layer is formed by accumulating a heat-resistant resin solution on either one or both surfaces of a porous polyolefin-based film using ultrafine fibers, which is very difficult to prepare by using the conventional fiber preparation methods, through an electrospinning method, the heat-resistant resin solution being a heat-resistant polymer resin dissolved in an organic solvent with a proper concentration.

The average diameter of the fibers greatly affects the porosity and the pore size distribution in the ultrafine fibrous layer. That is, the smaller the diameter of the fibers, the smaller the pore size, thereby the pore size distribution being smaller. Further, the smaller the diameter of the fibers, the more increased the specific-surface area of the fibers, thereby increasing the capacity of holding the electrolyte solution and decreasing the possibility of the electrolyte solution being leaked. Thus, the diameter of the fibers in the heat-resistant ultrafine fibrous layer is in the range of 1-3000 nm, preferably 1-1000 nm ° C., and more preferably 50-800 nm.

And, the pore size in the heat-resistant ultrafine fibrous layer is in the range of 1-5000 nm, preferably 1-3000 nm, and more preferably 1-1000 nm, so that an excellent capacity of holding the electrolyte solution can be maintained without leakage.

The porosity of the heat-resistant ultrafine fibrous layer should not be less than that of the porous polyolefin film so that the polyolefin separator laminated with the heat-resistant fibrous layer may maintain the high ionic conductivity, thus to obtain excellent cycling characteristics when a battery is assembled. Therefore, the porosity of the heat-resistant ultrafine fibrous layer is 30-95%, and preferably 40-90%.

In general, when the polyolefin separator is exposed to a temperature of 150° C., a thermal contraction of more than 20% occurs. Accordingly, the thickness of the heat-resistant ultrafine fibrous layer in accordance with the present invention is not specifically set so long as the thermal contraction thereof can be maintained at less than 20%, ranging from 1 μm in minimum to the thickness of the polyolefin separator in maximum, preferably 1-20 μm, and more preferably 1-10 μm.

In order to enhance the adhesion force and the holding capacity between an electrode and the heat-resistant ultrafine fibrous layer and between the heat-resistant ultrafine fibrous layer and a polyolefin separator, the heat-resistant ultrafine fibrous layer according to the present invention may include a polymer resin with a melting point of less than 180° C. and having a swelling characteristic in the electrolyte solution. This polymer resin is not limited to a certain type as long as it can form ultrafine fibers through the electrospinning process. Examples of a resin having a melting point of less than 180° C. and having a swelling characteristic in the electrolyte solution are as follows: polyvinyllidene fluoride, poly(vinyllidene fluoride-co-hexafluoropropylene), perfluoropolymer, polyvinylchloride or polyvinyllidene chloride and copolymers thereof, polyethylene glycol derivatives including polyethylene glycol dialkylene ether, polyethylene glycol dialkylene ester, poly-oxide including poly(oxymethylene-oligo-oxyethylene), polyethylene oxide and polypropylene oxide, polyvinyl acetate, poly(vinylpyrrolidone-vinyl acetate), polystyrene, and polystyrene acrylonitrile copolymers, polyacrylonitrile copolymer including polyacrylonitrile, polyacrylonitrile methylmethacrylate copolymers, polymethylmethacrylate, polymethylmethacrylate copolymers and mixtures thereof. However, without being limited to the aforementioned examples, any polymer may be used as long as it has electrochemical stability, affinity to an organic electrolyte solution and an excellent adhesion force with the electrode. In the present invention, a fluorine resin, such as polyvinyllidene fluoride, is more preferable.

In accordance with the present invention, the polymer resin having a swelling characteristic in the electrolyte solution forms a mixed solution with a heat-resistant polymer resin so as to be used as an electrospinning solution to form ultrafine heat-resistant fibrous layers. However, a heat-resistant fibrous layer with two kinds of ultrafine fibers mixed may be formed by electrospinning a polymer resin solution having a swelling characteristic in the electrolyte solution and a heat-resistant polymer resin solution through separate spinning nozzles.

According to the present invention, the heat-resistant ultrafine fibrous layer contains the polymer components of 0-95 wt % which have a melting point of less than 180° C. and a swelling characteristic in the electrolyte solution.

According to the present invention, an inorganic additive may be added into the heat-resistant ultrafine fibrous layer, that is, the heat-resistant polymer resin, or polymer resin of a swelling characteristic, or both in order to enhance the mechanical properties, ionic conductivities, electrochemical characteristics, and interaction with the porous film which is a support. The inorganic additives which may be used in the present invention can be a metallic oxide, a metallic nitride, and a metallic carbide, such as TiO₂, BaTiO₃, Li₂O, LiF, LiOH, Li₃N, BaO, Na₂O, Li₂CO₃, CaCO₃, LiAlO₂, SiO₂, Al₂O₃, PTFE, and mixtures thereof. The content of the inorganic additives is generally 1-95 wt % with respect to the polymer constituting the ultrafine fibrous layer, and preferably 5-50 wt %. In particular, it is preferable to use glass components containing SiO₂ in order to suppress an increase in the battery temperature due to a disintegration reaction between the cathode and the electrolyte solution and a chemical reaction causing gas generation.

In the present invention, in order to enhance the adhesion force between the polyolefin layer and the heat-resistant ultrafine fibrous layer and to control the porosity and thickness of the heat-resistant ultrafine fibrous layer, the heat-resistant ultrafine fibrous layer may be accumulated on the polyolefin separator and then laminated by compression below a certain temperature, or the separator of the present invention may be inserted between the anode and the cathode and then laminated by compression below a certain temperature. Herein, the lamination should be done at a temperature at which the properties of the polyolefin separator are not destroyed by the lamination operation.

In the secondary battery preparation according to the present invention, the polyolefin separator having the heat-resistant ultrafine fibrous layer is inserted between an anode containing a positive active material and a cathode containing a negative active material, laminated by compression, and then injected with an organic electrolyte solution or a polymer electrolyte. The positive active material may include lithium-cobalt complex oxide, lithium nickel complex oxide, nickel manganese complex oxide and olivine-type phosphate compound. The negative active material is not specifically limited, as long as it can be used in an anhydrous electrolyte battery such as a lithium secondary battery. For example, there are carbon ingredients such as graphite and coke, tartaric oxide, metallic lithium, silicon dioxide, oxide titanium compound, and mixtures thereof.

The kinds of lithium salts contained in the organic electrolyte solution or the polymer electrolyte are not specifically limited, and can be any lithium salts generally used in the lithium secondary battery field. For example, it can be one or a mixture of LiPF6, LiClO4, LiAsF6, LiBF4, LiCF3SO3, LiN(SO2CF3)2, LiN(SO2C2F5)2, LIPF6-x(CnF2n+1)x(1<x<6, N=1 or 2). Among them, LiPF₈ is more preferable. The concentration of lithium salts is 0.5-3.0M, but an organic electrolyte solution of 1M is generally used.

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention.

### Example 1-1

In order to prepare heat-resistant polymer ultrafine fibers by electrospinning, 15 g of [poly(meta-phenylene isophthal amide), Aldrich] was added into 85 g of dimethylacetamide (DMAc), and then stirred at room temperature, thereby obtaining a heat-resistant polymer resin solution. The heat-resistant polymer resin solution was inputted to a barrel of electrospinning equipment as shown in FIG. 1, and then was discharged using a metering pump at a rate of 1000/min. Herein, an electric charge of 17 kV was applied to the spinning nozzle using a high-voltage generator, so that a poly(meta-phenylene isophthal amide) ultrafine fibrous layer having a thickness of 10 μm was coated onto both surfaces of a polyethylene porous layer (Celgard 2730) having a thickness of 21 μm and a porosity of 43%, respectively. Herein, the coated amount was 2.5 g/m².

The polyethylene porous film coated with the previously prepared poly(meta-phenylene isophthal amide) ultrafine fibrous layer was laminated by compression at a temperature of 100° C., so that the poly(meta-phenylene isophthal amide) ultrafine fibrous layer of one surface of the polyethylene porous film was compressed to be 5 μm in thickness, thereby preparing a separator. The porosity of the poly(meta-phenylene isophthal amide) ultrafine fibrous layer was 80%. The shrinkage rate was 2.2% and 5.5% at temperatures of 120° C. and 150° C., respectively. The uptake of the electrolyte solution was 210%.

### Example 1-2

In order to prepare heat-resistant polymer ultrafine fibers by electrospinning, 7.5 g of [poly(meta-phenyleneisophthal amide), Aldrich] and 7.5 g of poly(vinylidene fluoride-co-hexafluoropropylene) copolymer (Kynar 2801) were added into 85 g of dimethylacetamide (DMAc), and then stirred at room temperature, thereby obtaining a heat-resistant polymer mixed resin solution. Using the same method as in Example 1, the heat-resistant polymer mixed resin solution was coated onto both surfaces of a polyethylene porous film (Celgard 2730) so that a heat-resistant polymer ultrafine fibrous layer was compressed to be 5 μm in thickness, thereby preparing an integrated separator. Herein, the coated amount was 2.42 g/m². Herein, the fibrous layer contained fibers having a fibrous shape of heat-resistant polymeric materials and a fibrous shape of swelling polymeric materials. The porosity of the ultrafine fibrous layer was 79%. The shrinkage rate at temperatures of 120° C. and 150° C. was 0.5% and 3.2%, respectively. The absorption rate of the electrolyte solution was 250%.

### Example 1-3

It was the same as in Example 1-2 except that poly(vinylidene fluoride) (PVdF, Kynar 761) was used, instead of poly(vinylidene fluoride-co-hexafluoropropylene) copolymer (Kynar 2801). In this case, the coated amount was 2.7 g/m². The porosity of the ultrafine fibrous layer was 84.2%. The shrinkage rate at temperatures of 120° C. and 150° C. was 0.2% and 1.8%, respectively. The uptake of the electrolyte solution was 300%.

### Example 1-4

It was the same as in Example 1-1 except that 15 wt % of poly(meta-phenylene isophthalamide) solution through one nozzle and 15 wt % of poly(vinylidene fluoride-co-hexafluoropropylene) copolymer solution through the other nozzle were electrospun at a rate of 100 μl/min, respectively, thereby preparing a mixed fibrous layer with poly(meta-phenylene isophthalamide) ultrafine fibers and a poly(vinylidene fluoride-co-hexafluoropropylene) copolymer ultrafine fibers. That is, this fibrous layer included two kinds of fibers, one including a fibrous form of heat-resistant polymeric materials, and the other including a fibrous form of swelling polymeric materials. Herein, the coated amount was 2.61 g/m². The porosity of the ultrafine fibrous layer was 86%. The shrinkage rate at temperatures of 120° C. and 150° C. was 1.1% and 3.5%, respectively. The uptake of the electrolyte solution was 320%.

uptake of the electrolyte solution was 320%.

### Example 1-5

The heat-resistant separator prepared in Example 1-2 was inserted between an anode and the cathode, underwent a hot-press lamination process by using a preheated roller at approximately 80° C., was immersed in a 1M LiPF₆ EC/DMC/DEC(1/1/1) solution, and then was injected with the electrolyte solution, and was vacuum-sealed within an aluminum plastic pouch, thus to prepare a lithium secondary battery. Then, the prepared lithium secondary battery was stored and ripened at approximately 50° C. before use. A capacity of 95% was maintained after the battery performed 200 charging/discharging cycles at room temperature.

### Comparison Example 1

15 g of [poly(meta-phenylene isophthalamide), Aldrich] was added into 85 g of dimethylacetamide (DMAc), and then stirred at room temperature, thereby obtaining a heat-resistant polymer resin solution. A polyethylene porous film (Celgard 2730) having a thickness of 21 μm and a porosity of 43% was impregnated in the heat-resistant polymer resin solution, thereby preparing coated films having two surfaces, each surface having a thickness of 5 μm. And then, the resultant was immersed into a coagulation solution of dimethylacetamide (DMAc) mixed with water (1:1), was washed, and then was dried. The thermal shrinkage of the polyethylene porous film, which was coated with the poly(meta-phenylene isophthalamide) heat-resistant film, was 0.6% and 2.3% at temperatures of 120° C. and 150° C., respectively. The uptake of the electrolyte solution was 120%. A capacity of 79% was maintained after the battery, which was prepared by using the film, had performed 200 charging/discharging cycles at room temperature.

### Comparison Example 2

7.5 g of poly(meta-phenylene isophthalamide), (Aldrich] and 7.5 g of poly(vinylidene fluoride-co-hexafluoropropylene) copolymer (Kynar 2801) were added into 85 g of dimethylacetamide (DMAc), and then stirred at room temperature, thereby obtaining a transparent heat-resistant polymer resin solution. A polyethylene porous film (Celgard® 2730) having a thickness of 21 μm and a porosity of 43% was impregnated in the heat-resistant polymer resin solution, thereby preparing coated films having two surfaces, each surface having a thickness of 5 μm. And then, the resultant was immersed into a coagulation solution mixed with dimethylacetamide and water (1:1), was washed, and then was dried. The thermal shrinkage of the polyethylene porous film, which was coated with the poly(meta-phenylene isophthalamide) heat-resistant film, was 0.15% and 2.3% at temperatures of 120° C. and 150° C., respectively. The uptake of the electrolyte solution was 125%. A capacity of 83% was maintained after the battery, which was prepared by using the film, had performed 200 charging/discharging cycles at room temperature.

### Example 2-1

In order to prepare heat-resistant polymer ultrafine fibers by electrospinning, a polyethylene porous film (Celgard 2730) which was integrally laminated with polyimide ultrafine fibers was prepared using the same method as in Example 1-1, except for using a solution in which 20 g of a polyimide [Matrimid 5218, Ciba Specialty Co.] was added into 80 g of dimethylacetamide (DMAc). Herein, the coated amount was 2.85 g/d. The shrinkage rate was 5.95% and 15.8% at temperatures of 120° C. and 150° C., respectively. The uptake of the electrolyte solution was 214% (and polyethylene porous film was 118%). The porosity of the ultrafine fibrous layer was 81%.

### Example 2-2

In order to prepare heat-resistant polymer ultrafine fibers by electrospinning, a polyethylene porous film (Celgard 2730) which was integrally laminated with polyimide ultrafine fibers was prepared using the same method as in Example 1-1, except for using a solution in which 7.5 g of a polyimide [Matrimid 5218, Ciba Specialty Co.] and 7.5 g of poly(vinylidene fluoride-co-hexafluoropropylene) copolymer (Kynar 2801) were added into 80 g of a solution of dimethylacetamide (DMAc) mixed with tetrahydrofuran (7:3). Herein, the coated amount was 2.49 g/m². The porosity of the ultrafine fibrous layer was 86%. The shrinkage rate was 2.45% and 5.4% at temperatures of 120° C. and 150° C., respectively. The uptake of the electrolyte solution was 224%. A capacity of 91% was maintained after the battery, which was prepared by using the film, had performed 200 charging/discharging cycles at room temperature.

### Example 2-3

In order to prepare heat-resistant polymer ultrafine fibers by electrospinning, a polyethylene porous film (Celgard 2730) which was integrally laminated with polyimide ultrafine fibers was prepared using the same method as in Example 1-1, except for using a solution in which 5 g of a polyimide [Matrimid 5218, Ciba Specialty Co.] and 15 g of poly(vinylidene fluoride) were dissolved in 80 g of dimethylacetamide (DMAc). Herein, the coated amount was 2.30 g/d. The porosity of the ultrafine fibrous layer was 86.3%. The shrinkage rate was 1.5% and 5.0% at temperatures of 120° C. and 1500, respectively. The uptake of the electrolyte solution was 302%. A capacity of 94% was maintained after a battery prepared by using the film had performed 200 charging/discharging cycles at room temperature.

### Example 3

In order to prepare heat-resistant polymer ultrafine fibers by electrospinning, a polyethylene porous film (Celgard 2730) which was integrally laminated with polyetherimide ultrafine fibers was prepared using the same method as in Example 1-1, except for using a solution in which 14 g of polyetherimide [ULTEM 1000, General Electric Co.] was dissolved in 86 g of −1,1,2-trichloroethane (TCE). Herein, the coated amount was 2.2 g/m². The porosity of the ultrafine fibrous layer was 78%. The shrinkage rate was 1.6% and 6.5% at temperatures of 120° C. and 150° C., respectively. The uptake of the electrolyte solution was 220%. A capacity of 87% was maintained after a battery prepared by using the film had performed 200 charging/discharging cycles at room temperature.

### Example 4

In order to prepare heat-resistant polymer ultrafine fibers by electrospinning, a polyethylene porous film (Celgard 2730) which was integrally laminated with polytrimethylene terephthalate ultrafine fibers was prepared using the same method as in Example 1-1, except for using a solution in which 10 g of polytrimethylene terephthalate (intrinsic viscosity of 0.92, Shell Co.) was dissolved into 90 g of a solution of trifluoroe acetic acid mixed with methylene chloride (1:1). Herein, the coated amount was 2.53 g/m². The porosity of the ultrafine fibrous layer was 81%. The shrinkage was 1.35% and 7.3% at temperatures of 120° C. and 150° C., respectively. The uptake of the electrolyte solution was 240%.

### Example 5

In order to prepare heat-resistant polymer ultrafine fibers by electrospinning, a polyethylene porous film (Celgard® 2730) which was integrally laminated with polyurethane ultrafine fibrous layer was prepared using the same method as in Example 1-1, except for using a solution in which 7.5 g of polyurethane [Pelletan2 2363-80AE, Dow Chemical Co.] and 7.5 g of poly(vinylidene fluoride-co-hexafluoropropylene) copolymer (Kynar 2801) were dissolved into 85 g of a solution of dimethylacetamide (DMAc) mixed with acetone (7:3). Herein, the coated amount was 2.81 g/m². The porosity of the ultrafine fibrous layer was 86%. The shrinkage rate was 1.2% and 3.5% at temperatures of 120° C. and 150° C., respectively. The uptake of the electrolyte solution was 210%.

Porosity Measurement

Apparent porosity (%) of the heat-resistant ultrafine fibrous layer is determined (%) according to the following formula.

P (%)={1−(ρ_{M}/ρ_{P})}×100%

(P: apparent porosity, ρ_{M}: density of heat-resistant fibrous layer, ρ_{P}: density of heat-resistant polymer)

The apparent porosity (%) of the polyethylene separator in Example 1-1 was 45%.

Method for Measuring the Uptake of Electrolyte Solution

A polyethylene separator of 3 cm by 3 cm, which was integrated with the heat-resistant ultrafine fibrous layer prepared by Example 1-1, was immersed into 1M LIPF₆ EC/DMC/DEC(1/1/1) electrolyte solution for 2 hours at room temperature, and then after any excess electrolyte solution remaining on the surface thereof was removed by a filter paper, weighed to determine the amount of the electrolyte solution absorption. The amount of the electrolyte solution absorption of the polyethylene separator in Example 1-1 was 120%.

Measurement of Thermal Shrinkage

A polyethylene separator of 5 cm by 2 cm, which was integrated with the heat-resistant ultrafine fibrous layer prepared by Example 1-1, was inserted between two glass slides, and then tightened with a clip, and thereafter was left alone for 10 minutes at temperatures of 120° C. and 150° C., respectively, so as to calculate the shrinkage rate. The thermal shrinkage of the polyethylene separator in Example 1-1 was 10% and 38%, respectively.

Electrode Preparation

In the aforementioned examples and comparison examples, for the anode, a slurry including PVdF binder, super-P carbon, and LiCo0₂ (product of Japan Chemical Co.) was cast on an aluminum foil. For the cathode, a slurry including MCMB (product of Osaka Gas Co. Ltd.), PVdF, super-P carbon was cast on a copper foil. A theoretical capacity of the electrode was 145 mAh/g. However, the anode and the cathode included in the lithium secondary battery of the present invention are not limited to have the above-mentioned construction. The lithium secondary battery according to the present invention may be constructed by using the anodes and cathodes which are widely known to those skilled in the art. Further, in order to enhance the adhesion force between particles and metallic foils, the anode and cathode slurries were cast so that the thickness of the electrodes could be approximately 50 μm after a roll pressing.

1-18. (canceled)

19. A heat-resistant separator comprising a fibrous layer, coated on either one or both surfaces of a porous film;
the porous film having a porosity of between 30 and 80%;
the porosity of the fibrous layer being greater than or equal to the porosity of the porous film;
the fibrous layer comprising fibers of a form of polyimide that does not have a melting point; and wherein
the fibers of a form of polyimide comprise fibers with diameters in the range of 1-3000 nm.

20. The heat-resistant separator of claim 19, wherein the fibrous layer may further comprise fibers formed from a polymeric material which swells in an electrolyte solution.

21. The heat resistant separator of claim 19, further comprising a second fibrous layer formed from fibers of a polymeric material which swells in an electrolyte solution.

22. The heat-resistant separator of claim 19, wherein the fibrous layer comprises fibers comprising a mixture of polyimide and swelling polymeric material.

23. The heat-resistant separator of claim 20, wherein the content of the fibrous form of the swelling polymeric material is 0-95 wt % with respect to the total amount of the polymeric components of the separator.

24. The heat-resistant separator of claim 20, wherein the swelling polymeric material is one selected from the group of polyvinylidene fluoride, poly(vinylidene fluoride-co-hexafluoropropylene), perfluoropolymer, polyvinylchloride or polyvinylidene chloride and copolymers thereof, polyethylene glycol derivatives including polyethylene glycol dialkylene ether, polyethylene glycol dialkylene ester, poly-oxide including poly(oxymethylene-oligo-oxyethylene), poly(ethylene oxide), polypropylene oxide, polyvinyl acetate, poly(vinylpyrrolidone-vinyl acetate), polystyrene, and polystyrene acrylonitrile copolymers, polyacrylonitrile copolymers including polyacrylonitrile, polyacrylonitrile methyl methacrylate copolymers, polymethylmethacrylate, polymethylmethacrylate copolymers, or a combination thereof.

25. The heat-resistant separator of claim 19, wherein the porous film comprises a polyolefin-based resin.

26. The heat-resistant separator of claim 25, wherein the melting point of the porous film is in the range of 100-180° C.

27. The heat-resistant separator of claim 25, wherein the porosity of the porous film is in the range of 40-60%.

28. The heat-resistant separator of claim 25, wherein the pore size of the porous film is in the range of 1-5000 nm.

29. The heat-resistant separator of claim 19, wherein the thickness of the fibrous layer is in the range of 1-20 um

30. The heat-resistant separator of claim 19, wherein the fibrous layer further comprises inorganic additives selected from the group of TiO₂, BaTiO₃, Li₂O, LiF, LiOH, Li₃N, BaO, Na₂O, Li₂CO₃, CaCO₃, LiAlO₂, SiO₂, AbO₃, or a mixture thereof.

31. The heat-resistant separator of claim 19, wherein the fibrous layer is formed by a process selected form the group consisting of electrospinning, electro blowing, and melt blowing.
